(19) United States
(12) Patent Application Publication
(10) Pub. No.: US 2003/0036892 A1
(43) Pub. Date: Feb. 20, 2003

(54) System for analyzing occupant motion during a vehicle crash

(76) Inventors: John R. Burge, Redondo Beach, CA (US); Robert Thibodeau, Huntsville, AL (US)

Correspondence Address: Eric K. Satermo, Registered Patent Agent, P.O. Box 19099, Irvine, CA, 92623-9099, US

(21) Appl. No.: 10/219,369

(22) Filed: Aug. 15, 2002

Related U.S. Application Data
(60) Provisional application No. 60/313,160, filed on Aug. 17, 2001.

(51) Int. Cl. G06G 7/48

(52) U.S. Cl. 703/8

(57) ABSTRACT

An occupant motion system for managing multiple simulations runs, enabling crash-induced occupant motion to be analyzed across variations in crash conditions and other variables. The system uses a computer system configured to accept multiple values or statistical distributions for input parameters based on an analysis type selected by the user. By automating the specification of input parameters into an occupant simulation system, multiple crash scenarios can be analyzed simultaneously and statistical results can be produced for the occupant motion in a particular crash.

### CROSS REFERENCE TO RELATED APPLICATION

The present application claims priority under 35 U.S.C. § 119(e) on U.S. Provisional Application for Patent Serial No. 60/313,160 filed Aug. 17, 2001.

### FIELD OF THE INVENTION

This invention relates to occupant simulation systems that assist users in analyzing the motion of occupants during a vehicle crash.

### BACKGROUND OF THE INVENTION

Automobile crashes are a leading cause of death and injury in the United States. Annually, automobile crashes injure five million people, resulting in 40,000 deaths and 250,000 life-threatening injuries. The lifetime economic costs to society are estimated to exceed $100 billion per year in the United States. Automobile crashes are a global problem, and the World Health Organization (WHO) predicts they will become the third leading cause of worldwide death and disease within 20 years. A better understanding of the motions of automobile occupants during a crash is essential for researchers and vehicle designers to improve the crashworthiness of automobiles.

Automobile crashes also place a large financial burden on society, particularly through their associated insurance and litigation costs. Lawsuits related to automobile crashes are the most common type of tort litigation brought against businesses and governments. Automobile liability costs in the United States consume approximately 1.24 percent of the gross domestic product. Fraudulent crash-related medical claims are estimated to cost an annual $13 to $18 billion alone. An increased ability to understand how and why people are injured in automobile crashes is essential to reducing these costs.

Crash testing is a commonly used method of analyzing crash-induced occupant motion by various entities including government agencies, universities, and non-profit organizations with an interest in vehicle safety. This testing includes crash testing with occupant surrogates such as test dummies, cadavers and animals, or even live human subjects for low-impact conditions. Because crash-induced occupant motion may only last for a tenth of a second in a typical moderate speed impact, occupant motion data is usually captured by either high-speed photography or by instrumenting occupants and surrogates with acceleration measurement devices. While crash testing is useful in studying crash-induced occupant motion, it can only be performed for a fraction of potential real-world crash scenarios due to its expense. In addition, crash testing is further limited in its ability to analyze the motion of live humans given ethical considerations that prevent the use of live humans in moderate to high-speed tests.

In order to overcome some of the drawbacks of crash testing, occupant simulation software has been developed that enables users to analyze crash-induced occupant motion. Widely used occupant simulation software packages include MADYMO® sold by TNO Automotive and the Articulated Total Body (ATB) model developed by the Air Force and the Calspan Corporation. These software packages enable their users to input data about a vehicle crash, and then run computer simulations that calculate occupant position as a function of time based on the laws of motion. The primary value of these programs is that they automate the calculation of occupant motion based on known physics formulas and principles—calculations that, if performed manually, would take days and perhaps months to complete.

While occupant simulation programs are useful in analyzing occupant motion based on a set of theoretical fixed parameters, one of their limitations is their ability to assist a user in evaluating the crash-induced motion of an occupant under real-world conditions. Rarely are all the parameters that impact crash-induced motion known for the real-world crash events that cause death and injury. In most real-world crashes, numerous variables are known to exist that impact occupant motion that must be treated as variables or analyzed as values with associated uncertainties in order to accurately characterize occupant motion. For example, in evaluating a particular vehicle model for the New Car Assessment Program (NCAP), the National Highway Transportation Safety Administration (NHTSA) will perform crash testing on a specimen vehicle. The objective of this testing is to provide information about the predicted crashworthiness of a particular vehicle based on a fixed set of vehicle impact conditions—e.g. a full frontal crash into a fixed barrier at 30 mph. In conducting this crash testing however, occupant motion conditions are also fixed that could vary widely in real-world scenarios under the identical set of vehicle impact conditions. These occupant motion variables may include:

Occupant Motion Variables

dummy dimensions

dummy seat position

seat back angle

seat pan angle

seat height

initial dummy body position

lap belt on/off

lap belt location

lap belt slack

shoulder belt on/off

shoulder belt location

shoulder belt slack

shoulder belt attachment point

head restraint height

head restraint backset

It is prohibitively expensive to analyze these variables with crash testing, and as a result the NCAP program is substantially limited in its ability to provide an accurate assessment of crashworthiness based on the real-world variability and uncertainty that may exist for these occupant motion variables. However, existing occupant simulation programs do not offer a viable solution as they are not designed to run a modeling simulation for a set of fixed parameters (like crash testing) and not a set of variables.

Other drawbacks to existing occupant simulation systems relates to the manner in which they are provided for use. Another drawback to existing occupant simulation programs is that they are designed for workstation installation and use, and are not accessible through a network pursuant to a thin-client system. As a result, these programs are further limited in their ability to facilitate the analysis of crash-induced occupant motion.

### SUMMARY OF THE INVENTION

An occupant motion system for managing multiple simulations runs enables crash-induced occupant motion to be analyzed across variations in crash conditions and other variables. The system uses a computer system configured to accept multiple values or statistical distributions for input parameters based on an analysis type selected by the user. By automating the specification of input parameters into an occupant simulation system, multiple crash scenarios can be analyzed simultaneously and statistical results can be produced for the occupant motion in a particular crash.

### BRIEF DESCRIPTION OF THE DRAWINGS

FIG. 1 is an overview block diagram of an occupant motion system.

FIG. 2 is a schematic block diagram of an occupant simulation system.

FIG. 3 is a schematic block diagram of a data management system.

FIG. 4 is a flowchart illustrating a process for managing execution of a case

FIG. 5a is an exemplary account access form.

FIG. 5b is an exemplary user access database.

FIG. 6 is an exemplary case specification form.

FIG. 7 is a flowchart illustrating a process for specifying components for a specific case analysis.

FIG. 8 is an exemplary component generation form.

FIG. 9 is an exemplary components database.

FIG. 10a is an exemplary key-in assignment form.

FIG. 10b is an exemplary illustration of a variable distribution.

FIG. 11 is an exemplary distribution creation form.

FIG. 12a is an exemplary upload assignment form.

FIG. 12b is an exemplary crash attribute in the form of a crash pulse.

FIG. 13 is an exemplary case input database.

FIG. 14 is an exemplary case output database.

FIG. 15 is a flowchart illustrating a process for analyzing run output.

### DETAILED DESCRIPTION OF THE INVENTION

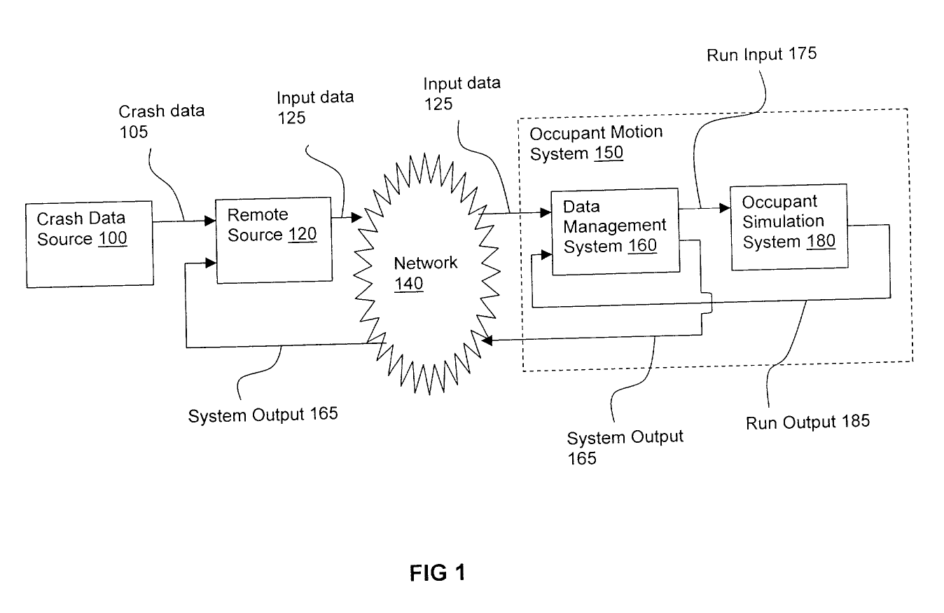

FIG. 1 shows an overview block diagram of the system. When a vehicle is involved in a crash, Crash Data 105 is generated by Crash Data Source 100. Crash Data 105 is then input into the Occupant Motion System 150 through a Remote Source 120 connected to a Network 140 (e.g. internet). The Occupant Simulation System 180 is instructed to run occupant simulations based on Run Input 175 received from the Data Management System 160. Each simulation performed by the Occupant Simulation System 180 is considered a “run,” and multiple runs requested by a user as part of a particular crash event analysis is considered a “case.” Existing Occupant Simulation Systems 180 known in the art are designed to handle runs, but are not designed to manage and automate the tasks involved with multiple runs and make use of the information that can be derived by managing and analyzing multiple runs as a case. In general, it is these latter tasks that the Data Management System 160 handles, enabling users to perform automated “what-if” scenarios, perform Monte Carlo analysis, perform sensitivity analysis, and incorporate uncertainty into the analysis of a particular crash scenario.

Crash Data Source 100 could be any source that generates Crash Data 105, including: (1) a crash data recorder (commonly known as a “black box”) located onboard the vehicle; (2) an accident investigation performed by an accident investigator such as an accident reconstructionist, police officer or claims examiner; or (3) information provided by an accident reconstruction software program such as PC CRASH, ED CRASH or ED SMAC. Crash Data 105 can include information about the vehicle occupants and vehicle crash forces. Crash Data 105 may include:

Component Data

Vehicle type

Number of occupants

Occupant dimensions

Seat dimensions

Cabin objects

Airbag deployment

Airbag inflation characteristics

Seat belt dimensions

Seat belt attachment points

Seat belt retractor type

Interior surface properties

Position Data

Seat track position

Seat pan height

Seat pan angle

Seat back angle

Head restraint height

Head restraint backset

Lap belt position

Lap belt slack

Shoulder belt position

Shoulder belt slack

Occupant posture in seat

Cabin Force Data

Delta v

Delta t

Peak g

Pulse shape

PDOF

X crash pulse

y crash pulse

z crash pulse

Vehicle rotation

Crash Data 105 is input into the Occupant Motion System 150 through a Remote Source 120 that could be any form of network access device. Remote Source 120 is preferably a personal computer (PC) of common use with a commonly used operating system such as Microsoft Windows and standard web browser software such as Microsoft Explorer or Netscape Navigator. Crash Data 105 is transferred to the Occupant Motion System 150 through a Network 140. Network 140 preferably includes connection to the internet or other wide area network which allows direct access by Remote Sources 120 located in other geographic areas.

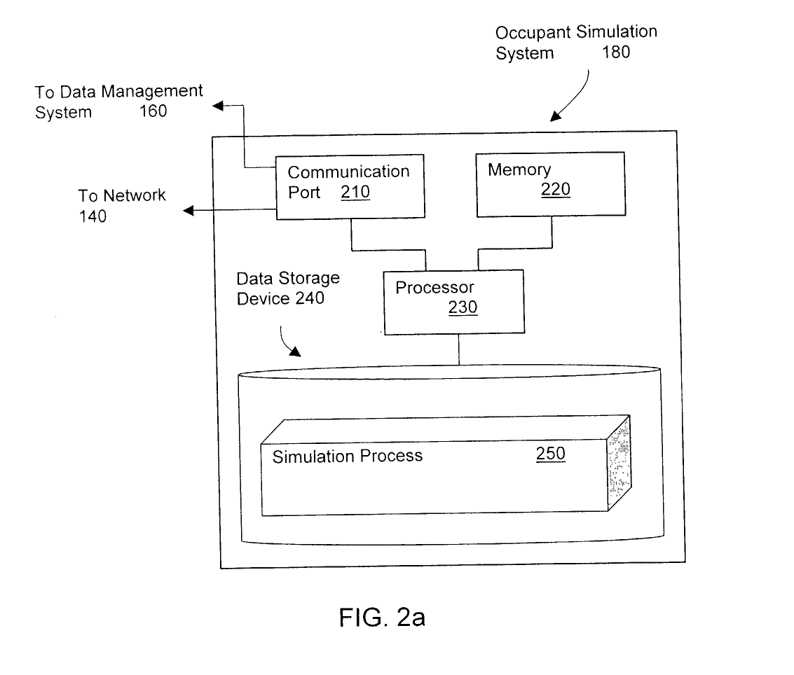

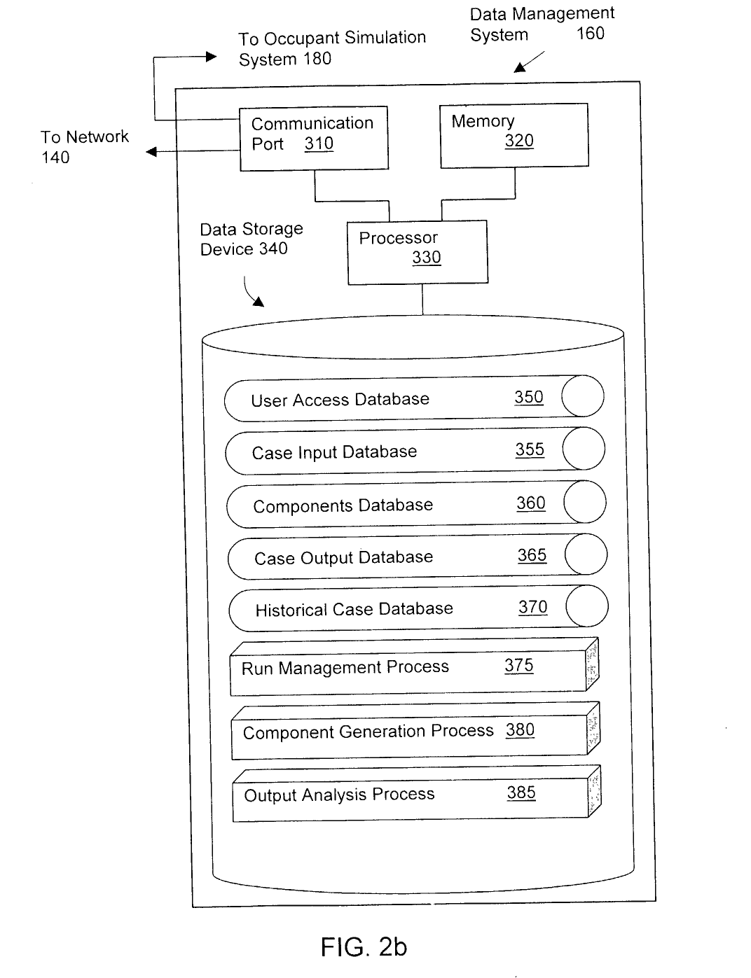

Occupant Motion System 150 receives Crash Data 105 and performs occupant simulations using this data which can be analyzed by the operator of the Remote Source 120 or anyone granted access to the Occupant Motion System 150 through Network 140. Occupant Motion System 150 includes an Occupant Simulation System 180 and a Data Management System 160. Occupant Simulation System 180 (shown in FIG. 2a) could be any computer housing occupant simulation software that is known in the art. Several occupant simulation software packages exist, although the most widely used are the Articulated Total Body (ATB) model and MADYMO—both of which utilize rigid body dynamics for modeling. The ATB model was originally developed by the United States Air Force, and is maintained by Wright Patterson Air Force Base. Commercial versions are available from several companies, including Veridian Engineering in Buffalo, N.Y. MADYMO is sold by TNO Automotive located in the Netherlands and is widely used in evaluating automotive safety and vehicle design by research entities, automobile manufacturers and suppliers, and government agencies. An exemplary Occupant Simulation System 180 is shown in FIG. 2a as a server including a Communication Port 210 in communication with Network 140 and Data Management System 160, a Memory 220, a Processor 230 and a Data Storage Device 240 for storing the computer code that instructs the particular Simulation Process 250 (e.g. ATB or MADYMO).

FIG. 2b depicts an exemplary block diagram of a Data Management System 160. The Data Management System 160 includes a Processor 330, Communication Port 310 and Memory 320 for managing the operations of the Data Management System 160, which may include: (1) managing user access to the system and payment for simulation services; (2) Accepting and formatting input of crash data for multiple simulation runs; (3) managing the selection of variables, variable values and statistical distributions used for assigning variable values; (4) generating run tables of parameters, variables, values and components to be used in simulation runs; (5) instructing the occupant simulation system to execute simulations according to run tables; (6) analyzing simulation results across multiple simulation runs, including performing statistical analysis; (7) presenting results to users; (8) managing database inquiries, sorts, and requests for analysis to be performed on run table sub-sets; (9) storing and retrieving historical data for users; (10) calculating and reporting statistics for system-wide usage. A Data Storage Device 340 is also shown as part of the Data Management System 160 which may contain a variety of databases including a User Access Database 350 for managing user system access and payment information, Case Input Database 355 for capturing and managing the data that is input into the Occupant Simulation System 180, Components Database 360 for storing and managing the components used for simulation runs, Case Output Database 365 for storing and managing the results of simulation runs and calculations performed by the Data Management System 160 and Historical Case Database 370 for long term storage of user records. In addition, Data Storage Device 340 is shown in FIG. 2b as including a Run Management Process 375 for managing the operations of the Occupant Simulation System 180, a Component Generation Process 380 for generating components such as occupants and vehicles based on user specifications, and an Output Analysis Process 385 for analyzing the results of simulation runs performed by the Occupant Simulation System 180.

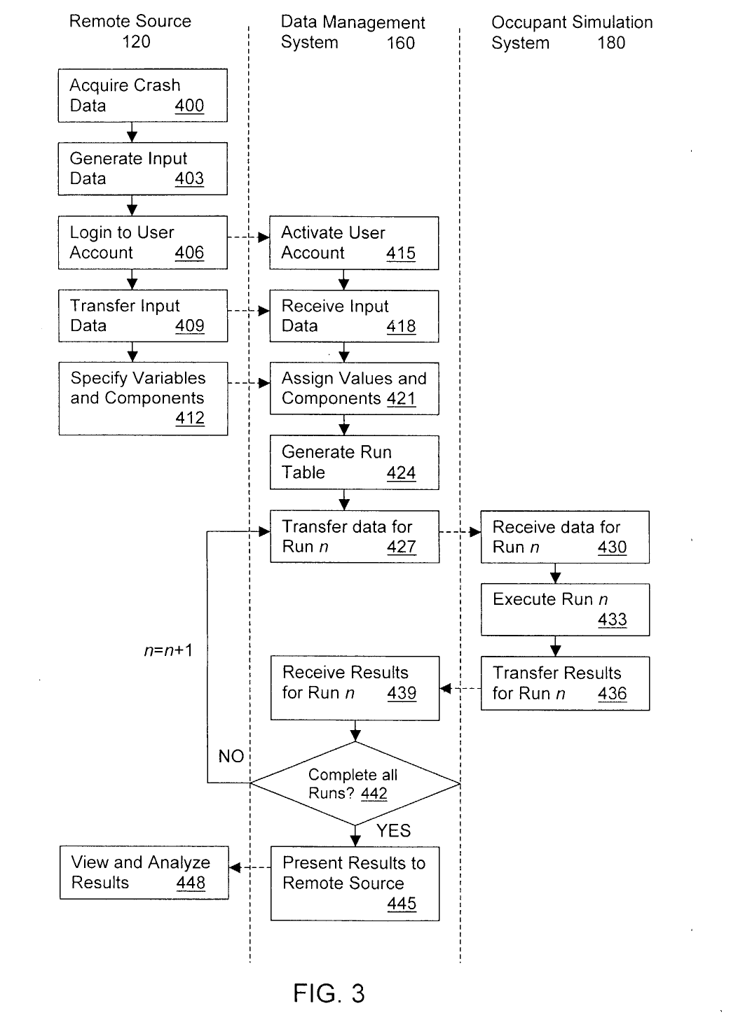

FIG. 3 shows an exemplary Run Management Process 375. Initially, a Remote Source acquires 400 crash data, generates 403 input data and logs in 406 to their user account specified in the Occupant Motion System. Once a user logs in, the Data Management System Activates 415 the user's account to enable them to utilize the system, bill them for services, and store the data they input into the system as well as the results that are generated. Input data is Transferred 409 from a Remote Source and Received 418 by the Data Management System which could include data about the components to be used in a simulation, component position information, cabin force data about the vehicle accelerations and movements, as well as any other data needed by an Occupant Simulation System to calculate occupant motion during the crash. Variables and components are selected 412 by the Remote Source and the Data Management System assigns 421 values and components based on those selections. Once all necessary values, components and parameters are provided for a given analysis, the Data Management System generates 424 a run table that will provide the Occupant Simulation System the parameters of each run to be executed for a particular case. The Data Management System then transfers 427 the data for a run to the Occupant Simulation System that receives 430 the data and executes 433 a simulation based on the data. The results of the simulation are then transferred 436 back to the Data Management System which receives 439 the results and determines 442 whether all the runs have been completed as specified in the run table. If the runs have not been completed, another set of run data is transferred 427 from the run table and received 430 by the Occupant Simulation System for another run to be performed. Once all runs specified in the run table are exhausted, the Data Management System presents 445 the results to the Remote Source that then views and analyzes 448 the results.

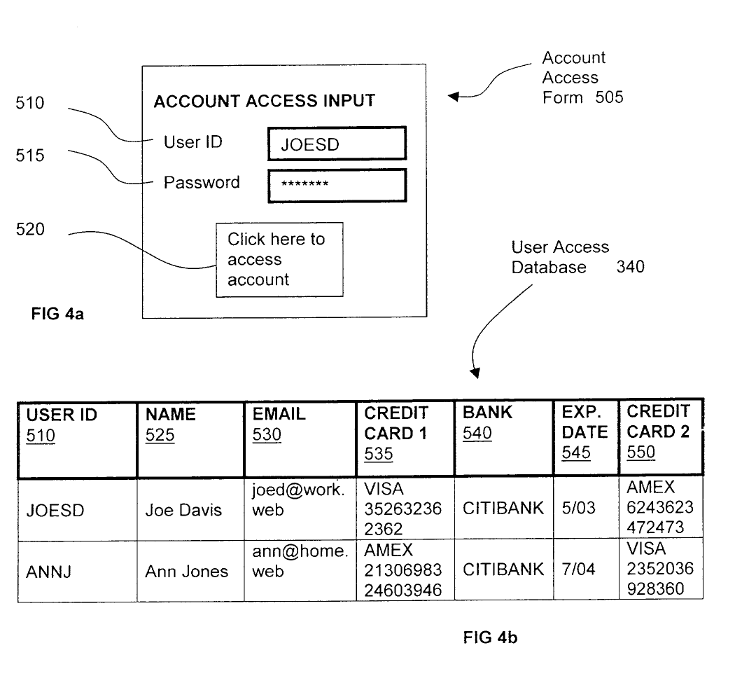

FIG. 4a shows an exemplary Account Access Form 505 that enables a user to input a User ID 510 and Password 515 from a Remote Source 120 and then instruct 520 the Data Management System 160 to authorize account access. This information is stored within a User Access Database 340, an example of which is shown in FIG. 4b, along with user Name 525, contact information such as Email 530 as well as payment identification information such as the credit card information shown by reference numerals 535-550.

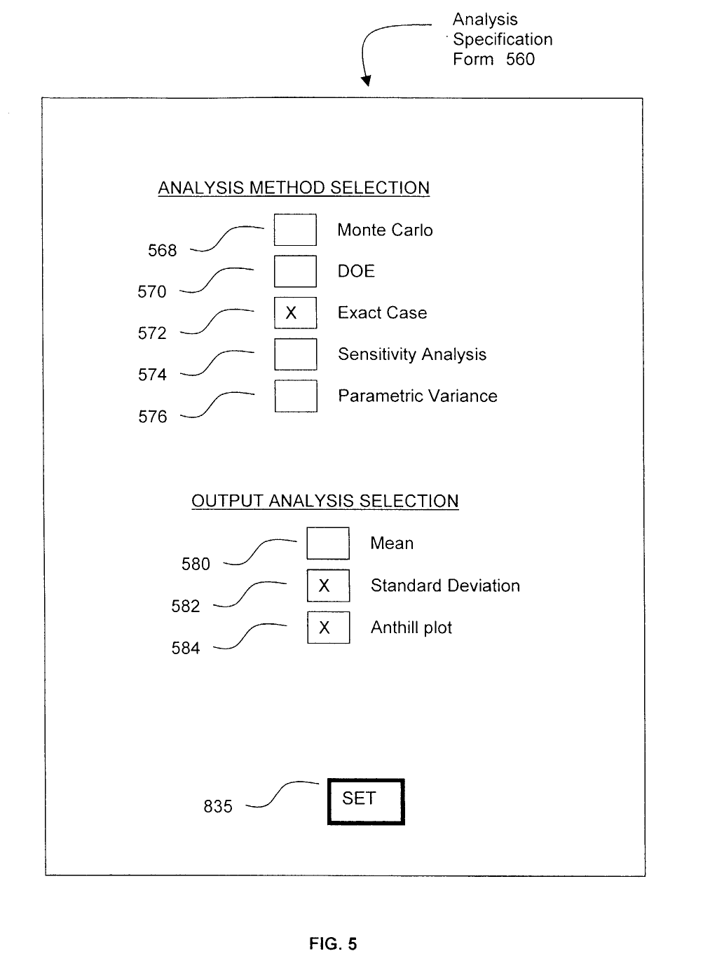

FIG. 5 shows an exemplary Analysis Specification Form 560 that enables a user to specify the method of analysis 568-576 to be utilized by the Occupant Motion System 150 in analyzing a particular set of data, as well as specify particular types of statistical analysis to be performed on the analysis results 580-584. Exemplary methods of analysis are shown here as including Monte Carlo Analysis 568, Design of Experiments (DOE) 570, Exact Case 572, Sensitivity Analysis 574 and Parametric Variance 576. The particular method of analysis chosen by the user will instruct the Data Management System 160 to prompt the user for specific data inputs that will vary based on the analysis method chosen. Exemplary output analysis selections are also shown as including Mean 580, Standard Deviation 582 and Anthill Plot 584. Once all selections have been made, the user can instruct the Data Management System 160 to accept the selections by clicking the Set 835 button.

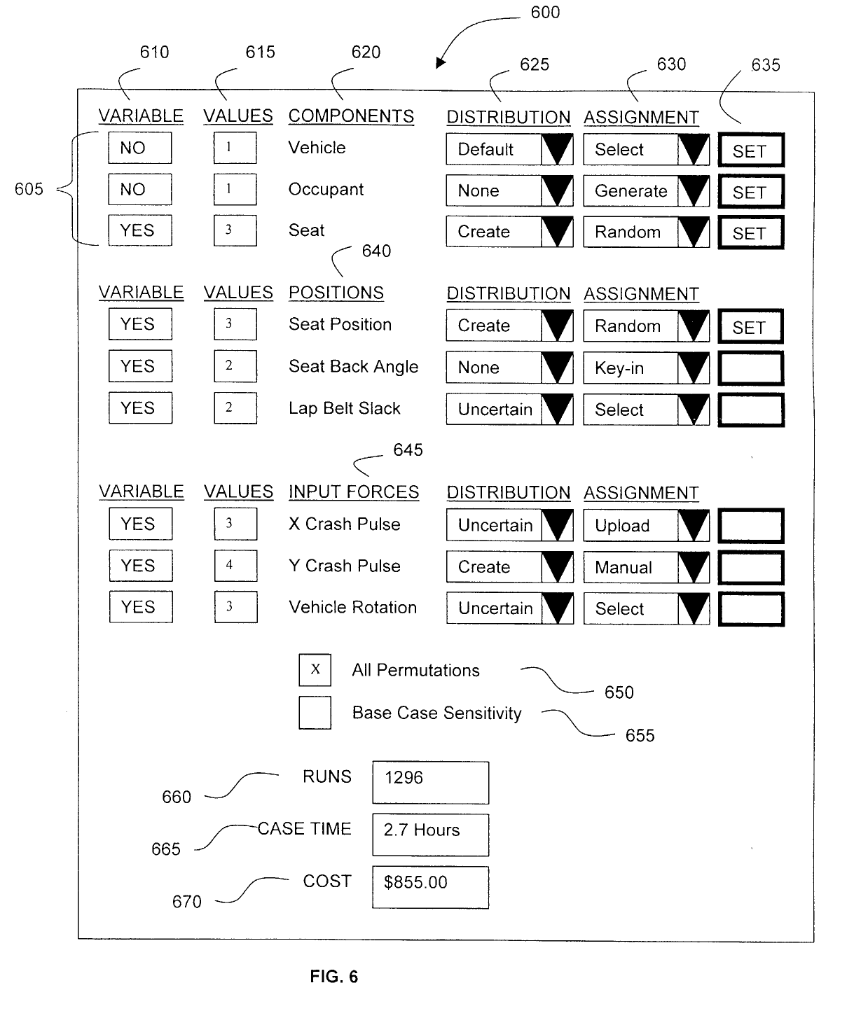

FIG. 6 shows an exemplary Case Specification Form 600 for a particular method of analysis selected by a user, here shown as a Monte Carlo analysis that enables a user to instruct the Data Management System 160 which Crash Attributes 605 the user would like to specify as Variables 610 and how many Values 615 the user would like to have assigned to each Variable 610 for a given Case. Crash Attributes 605 have been further characterized as Components 620, Positions 640 and Input Forces 645. Components 620 represent objects that need to be moved, modeled or otherwise accounted for by the Occupant Simulation System 180, including vehicles, occupants and seats. Positions 640 represent Crash Attributes 605 relating to the initial positions of Components 620 at the beginning of a simulation run, such as seat position, occupant position and head restraint backset. Input Forces 645 characterize the forces and accelerations acting up the particular vehicle such as crash pulse and principle direction of force (PDOF).

In the exemplary Case Specification Form 600 shown in FIG. 6, the user clicks on Set Button 635 in order to set specific values for Crash Attributes 605. Once set, the Set Button 635 indicates to the user that values have been set by the Data Management System 160—here indicated by showing the word “SET” in the Set Button 635. The user may request a case analysis type by either requesting that simulation runs be performed using All Permutations 650 of variable values, or by requesting that a Base Case Sensitivity 655 analysis be performed. Once values and an analysis type have been selected, the user receives feedback about the number of Runs 660 that will be required for a specified case, as well as the Time 665 and Cost 670.

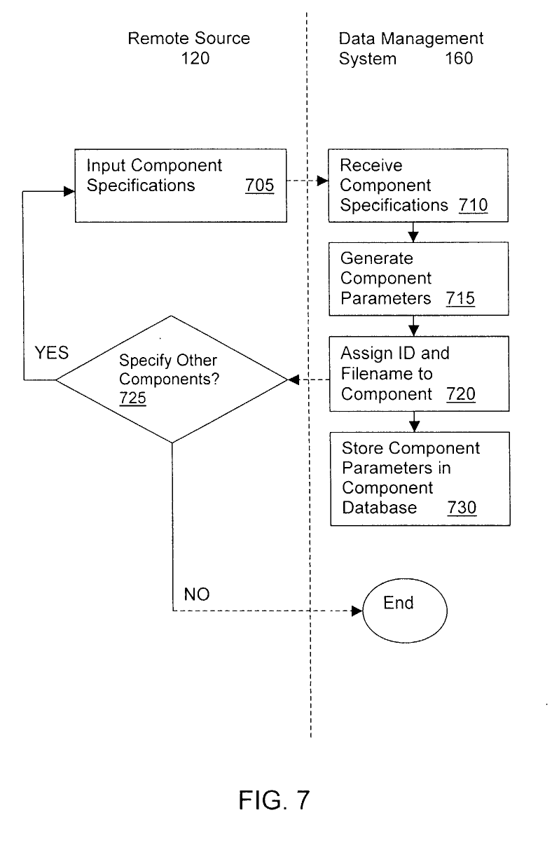

FIG. 7 is a flowchart illustrating a process for specifying Components 620 for a particular case analysis. Component specifications are first Input 705 by a Remote Source 120 and Received 710 by the Data Management System 160. The Data Management System 160 then Generates 715 component parameters that define the particular Component 620. An ID and Filename is then Assigned 720 to the Component 620. The Remote Source 120 then evaluates whether additional Components 620 need to be specified in order to execute the particular case, and repeats the process if affirmative. The Data Management System 160 proceeds to Store 730 the component parameters in the Component Database 360.

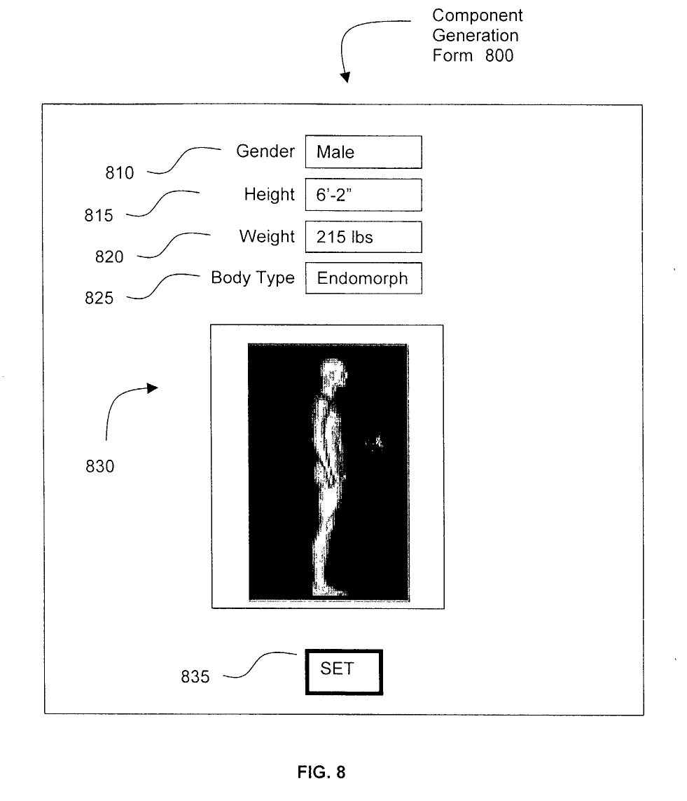

FIG. 8 is an exemplary Component Generation Form 800 that enables a user to cause the Data Management System 160 to generate a component (here shown as a Vehicle Occupant 830) by inputting component specifications into the form and clicking the Set Button 835. Here, Vehicle Occupant 830 is shown generated from specifying Gender 810, Height 815, Weight 820 and Body Type 825. Component generation software is known in the art for human and dummy representation, such as the Bodybuilder and Anthropos products by the TecMath corporation and Mannequin Pro from NexGen Ergonomics.

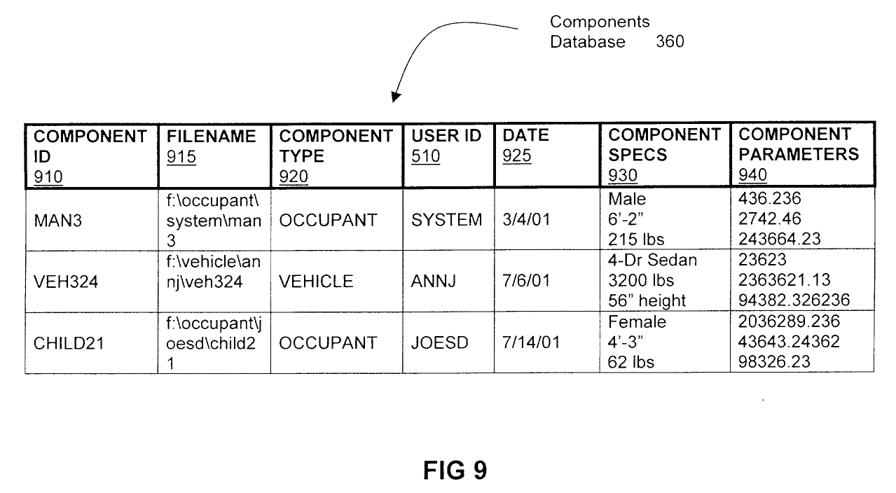

FIG. 9 is an exemplary Components Database 360 that maintains Components 620 that are part of a default component set within the Data Management System 160, as well as Components 620 generated by individual users using the Component Generation Process 380. Components Database 360 may include a Component ID 910 field for identifying the specific Component 620, a Filename 915 field for specifying the location of the Component 620 within the Data Management System 160 and a Component Type 920 for specifying whether the Component 620 is an occupant, vehicle or other object. A User ID 510 field enables the Data Management System 160 to segregate default components from those custom generated by users. Date 925 indicates the date the Component 620 was created or input in to the Data Management System 160. Component Specs 930 field contains the specifications that were input into the system to define the particular Component 620. Component Parameters 940 represent the parameters that the Occupant Simulation System 180 utilizes to define the Component 160.

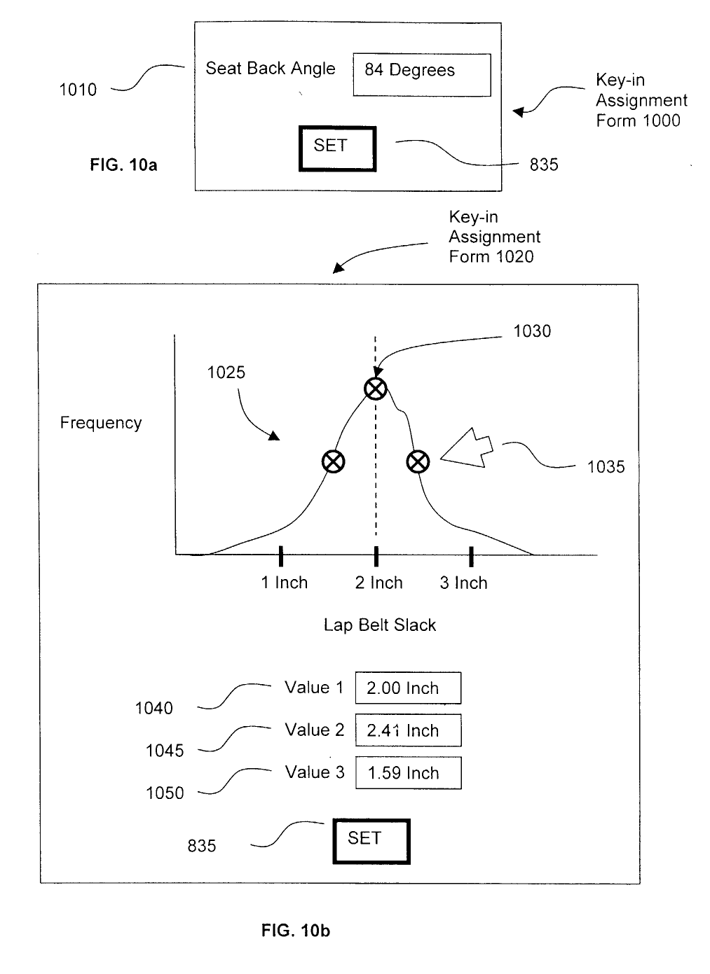

FIG. 10a is an exemplary illustration of a Key-in Assignment Form 1000 that can be used to specify a particular value for a Crash Attribute 605, here shown as a single value parameter Seat Back Angle 1010. Multiple value variables can also be accounted for. A Set Button 835 is shown to instruct the Data Management System 160 to accept the value which is keyed into the form.

FIG. 10b is an exemplary illustration of a Distribution 625, here shown as a distribution for Lap Belt Slack 1025. Distribution 625 can be a default distribution stored within the Data Management System 160, a distribution that is uploaded into the Data Management System 160 by a Remote Source 120, or a distribution that is custom specified by a user. A Median Value 1030 is shown, along with a Pointer Device 1035 for selecting values by clicking the Pointer Device 1035 at the desired point in the Distribution 625. Selected Values 1040, 1045 and 1050 are shown, as well as a Set Button 835 for requesting the Data Management System 160 to accept the selected values.

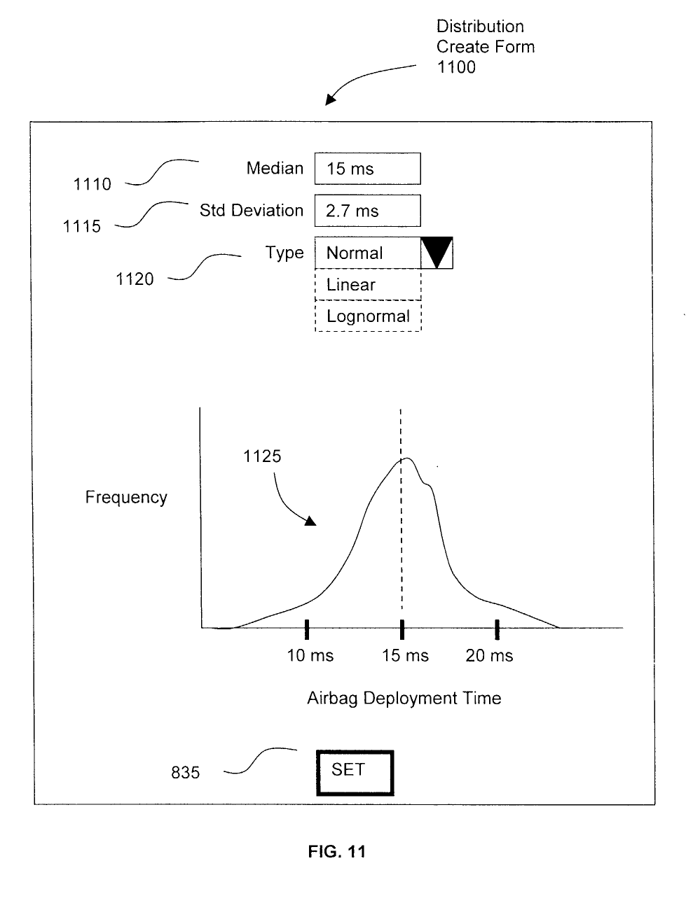

FIG. 11 is an exemplary Distribution Create Form 1100 that enables a user to create a Custom Distribution 1125, here shown as a normal distribution representing airbag deployment time. As shown here, a user has selected a Median 1110 value for the Distribution 625 as well as a Standard Deviation 1115 and a Distribution Type 1120. A Set Button 825 is shown for requesting the Data Management System 160 to accept the Custom Distribution 1125.

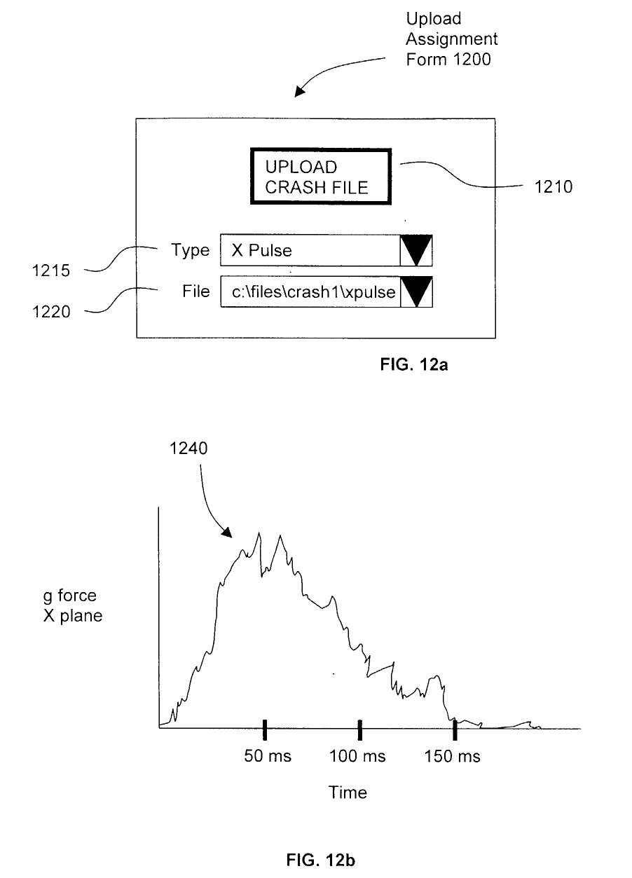

FIG. 12a is an exemplary Upload Assignment Form 1200 that enables a user to upload a Crash File 1215 shown here as an x pulse. A File ID 1220 is also shown, enabling the user to tell the Data Management System 160 the file location. The Data Management System 160 uploads the Crash File 1215 when instructed by the user by clicking the Upload Button 1210. FIG. 12b is an exemplary Crash Pulse 1240 that could comprise a Crash File 1215 for uploading through the Upload Assignment Form 1200.

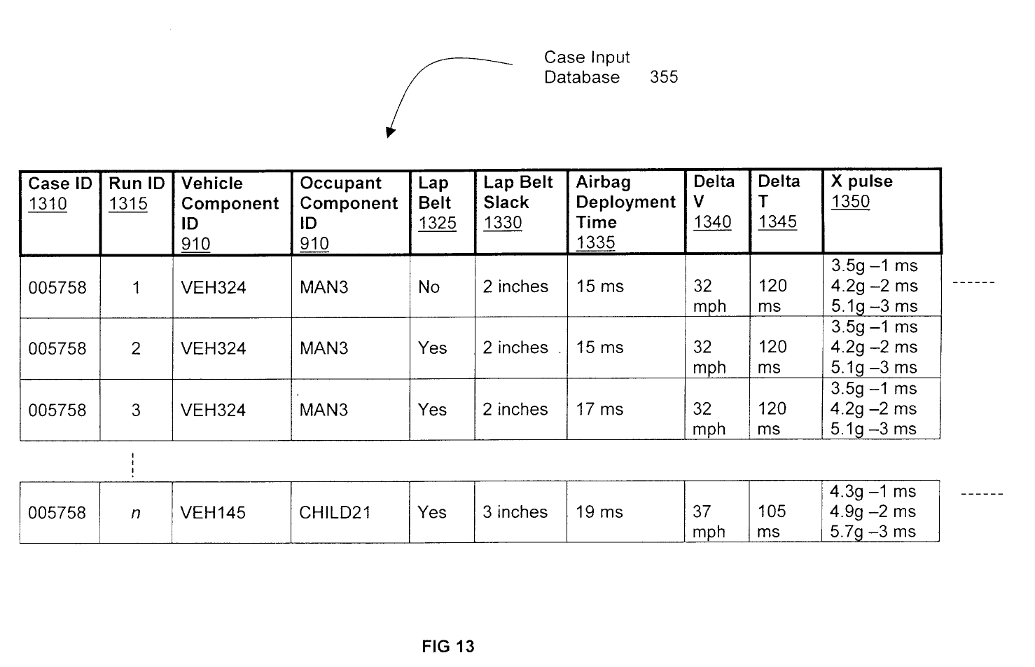

FIG. 13 is an exemplary illustration of a section of a Case Input Database 355 that is populated by users providing Input Data 125 to the Data Management System 160. Case Input Database 335 is shown as including a Case ID 1310 and Run ID 1315 for identifying which case the particular record is associated with as well as which run within that case it is associated with. All records associated with a particular Case ID 1310 comprise a Run Table that will be used in executing a case analysis using the Occupant Simulation System 180. A Component ID 910 is shown here both for an occupant and vehicle. Several Variables 610 are shown that have been assigned values by the Data Management System 160, including Lap Belt 1325, Lap Belt Slack 1330, Airbag Deployment Time 1335, Delta V 1340, Delta T 1345 and X pulse 1350.

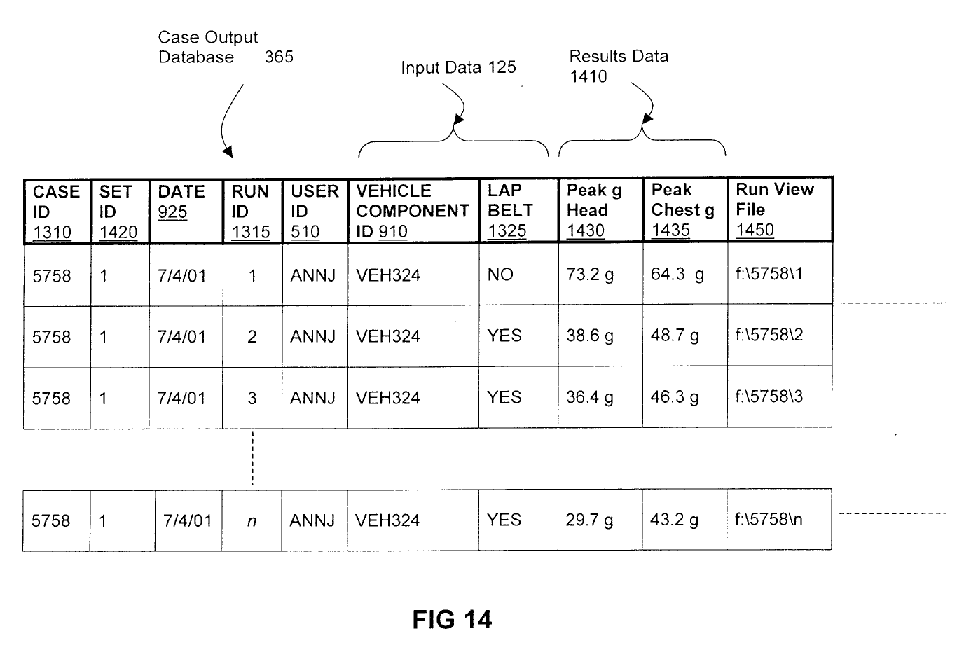

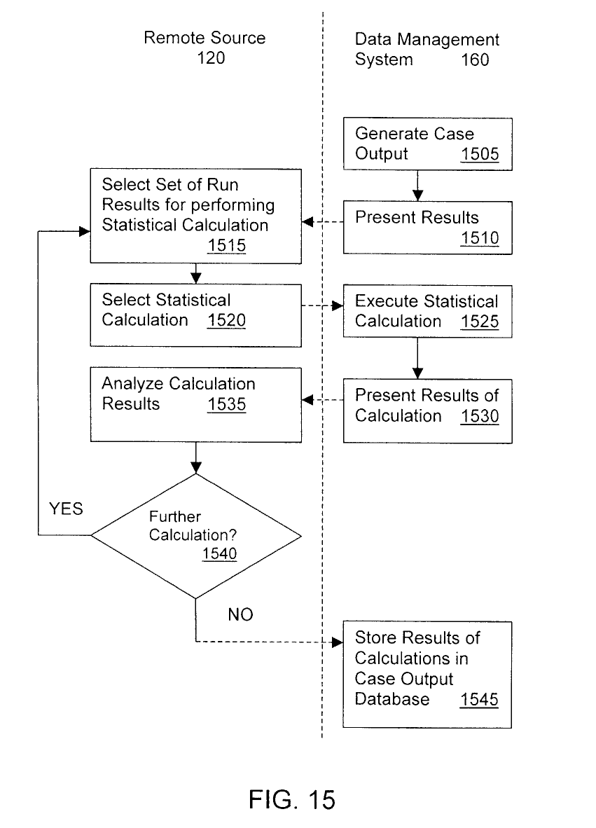

FIG. 14 is an exemplary illustration of a Case Output Database 365. The Case Output Database 365 contains much of the same information as the Case Input Database 335 as well as including the Results Data 1410 generated by the Occupant Simulation System 180, Run View Files 1450 and other data that is generated by the Occupant Simulation System 180 or processes executed by the Data Management System 160. Here, Case Output Database 365 is shown as including a Case ID 1310, Set ID 1420 for identifying case sub-sets that may have been sorted out of a case by a user, a Date 925 when the particular Set ID 1420 was created and a Run ID 1315 to identify the specific run that the record is associated with. A User ID 510 is also shown to identify the user with which the case is associated. Exemplary Input Data 125 is shown here as including a Component ID 910 in the form of a vehicle and Lap Belt 1325 as a variable with specified values. Exemplary Results Data 1410 is shown here as including Peak g Head 1430 and Peak Chest g 1435, both of which are standard calculations often performed by Occupant Simulation Systems 180 known in the art.

FIG. 15 is an exemplary illustration of an Output Analysis Process 385 executed within the Data Management System 160. Data Management System 160 Generates 1505 case output and then Presents Results 1510 to a Remote Source 120 which Selects 1515 a set of run results for performing a statistical calculation. The Remote Source 120 then Selects 1520 the desired statistical calculation which is then Executed 1525 by the Data Management System 160. The Data Management System 160 then Presents 1530 the results of the calculation to the Remote Source 120, which Analyzes 1535 the results and Determines 1540 whether further calculations are needed. If further calculations are needed, the Remote Source 120 Selects 1515 another set of run results. If further calculations are not needed, the Data Management System 160 Stores 1545 the results of the calculations in the Case Output Database 365.

Those skilled in the art will understand that the embodiments of the present invention described above exemplify the present invention and do not limit the scope of the invention to these specifically illustrated and described embodiments. The scope of the invention is determined by the terms of the appended claims and their legal equivalents, rather than by the described examples. In addition, the exemplary embodiments provide a foundation from which numerous alternatives and modifications may be made, which alternatives and modifications are also within the scope of the present invention as defined in the appended claims.

We claim:

1. An occupant motion system for managing a plurality of occupant simulations that calculate motion of an occupant within a vehicle during a crash, the occupant motion system comprising:
an occupant simulation system for performing the occupant simulations using input data including a plurality of parameters and a variable; and
a data management system in communication with the occupant simulation system for:
assigning a plurality of values to the variable of the input data; and
causing the occupant simulation system to perform an occupant simulation for each of the assigned values of the variable for all permutations of the parameters.

2. The occupant motion system of claim 1 wherein the data management system:
a) assigns a value to the variable of the input data; and
b) causes the occupant simulation system to perform an occupant simulation for the assigned value of the variable for all permutations of the parameters;
c) assigns another value to the variable;
d) repeats step (b) for the another value of the variable.

3. The occupant motion system of claim 1 wherein the data management system:
assigns an analysis identifier for occupant simulation output associated with a particular analysis being carried out by a user of the occupant motion system.

4. The occupant motion system of claim 3 wherein the data management system:
stores the occupant simulation output for a plurality of occupant simulations in a database in accordance with the analysis identifier, the simulation output including numerical data.

5. The occupant motion system of claim 4 wherein the data management system:
performs statistical calculations on the numerical data for a plurality of occupant simulations with common analysis identifiers.

6. The occupant motion system of claim 5 wherein the data management system:
assigns a plurality of values to the variable of the input data by selecting the plurality of values from a statistical distribution of values assigned to the variable.

7. The occupant motion system of claim 6 wherein the data management system:
receives the input data from a remote source.

8. The occupant motion system of claim 7 wherein the remote source:
communicates with the data management system via a network.

9. The occupant motion system of claim 8 wherein the data management system:
receives a payment identifier from the remote source specifying an account for use in providing payment for occupant motion simulations performed by the occupant motion system.

10. The occupant motion system of claim 9 wherein the data management system:
calculates a cost for providing occupant simulation services requested by a remote source and communicates the cost to the remote source prior to instructing the occupant simulation system to run the occupant simulations requested by the remote source.

11. The occupant motion system of claim 10 wherein the data management system:
receives a confirmation from the remote source that the cost has been received and to proceed with the simulations.

12. The occupant motion system of claim 11 wherein the data management system:
places the occupant simulation output on the network that enables a remote source to access the output.

13. The occupant motion system of claim 12 wherein the data management system:
communicates the occupant simulation output to a remote source by sending an email to the remote source.

14. An occupant motion system for managing occupant simulations to calculate motion of an occupant within a vehicle during a crash, the occupant motion system comprising:
a first processing means for performing the occupant simulations using input data including a plurality of parameters and a variable; and
a second processing means in communication with the first processing means, the second processing means for:
assigning a plurality of values to the variable of the input data; and
causing the first processing means to perform an occupant simulation for each of the assigned values of the variable for all permutations of the parameters.

15. The occupant motion system of claim 14 wherein the second processing means:
receives the input data from a remote source.

16. The occupant motion system of claim 15 wherein the remote source:
communicates with the second processing means via a network.

17. The occupant motion system of claim 16 wherein the second processing means is configured to receive a payment identifier from the remote source specifying an account for use in providing payment for occupant motion simulations performed by the occupant motion system.

18. The occupant motion system of claim 17 wherein the second processing means is configured to receive an analysis identifier for a particular analysis being carried out by a remote source.

19. The occupant motion system of claim 18 wherein the second processing means is further configured to store the occupant simulation output of a plurality of occupant simulations performed for a particular analysis in a database in accordance with the analysis identifier, the occupant simulation output including numerical data.

20. The occupant motion system of claim 19 wherein the second processing means is configured to perform statistical calculations on the numerical data for a plurality of occupant simulations with common analysis identifiers.

21. The occupant motion system of claim 14 wherein the second processing means:
assigns a plurality of values to the variable of the input data by selecting the plurality of values from a statistical distribution of values assigned to the variable.

22. The occupant motion system of claim 21 wherein the assigned statistical distribution is a default distribution for the variable stored in a database within the occupant motion system.

23. The occupant motion system of claim 21 wherein the assigned statistical distribution is input from the remote source.

24. The occupant motion system of claim 14 wherein the input data includes a selection of a particular vehicle interior configuration stored in a database within the occupant motion system.

25. The occupant motion system of claim 24 wherein the input data includes the vehicle dimensions for use in a particular analysis being carried out by a remote user and wherein the occupant motion system further includes a vehicle configuration system that configures a vehicle interior based on the vehicle dimensions.

26. The occupant motion system of claim 14 wherein the input data includes the occupant dimensions for use in a particular simulation and wherein the occupant motion system further includes an occupant configuration system that configures an occupant based on the occupant dimensions.

27. The occupant motion system of claim 17 wherein the second processing means is configured to:
calculate a cost for providing occupant simulation services requested by a remote source; and
communicate the cost to the remote source prior to instructing the occupant simulation system to run the occupant simulations requested by the remote source.

28. The occupant motion system of claim 27 wherein the second processing means is configured to:
receive a confirmation from the remote source that the cost has been received and to proceed with the simulations.

29. The occupant motion system of claim 28 wherein the second processing means is configured to:
place the occupant simulation output on the network that enables a remote source to access the output.

30. The occupant motion system of claim 29 wherein the second processing means is configured to:
communicate the occupant simulation output to a remote source by sending an email to the remote source.

31. A method for using a crash event database, the crash event database including input data and results data, the results data being generated from occupant simulations performed using input data, the method comprising:
receiving input data from a plurality of remote users, the input data including a vehicle identifier;
receiving results data from occupant simulations performed using the input data;
storing the input data and results data in a crash event database;
receiving input data from a remote user that includes a vehicle identifier; and
providing the remote user one or more records from the crash event database with the corresponding vehicle identifier.

32. A method for using an occupant motion system to predict the crashworthiness of a vehicle under a specific crash configuration, the crashworthiness being effected by variables of uncertain value, the specific crash configuration being defined by a plurality of fixed parameters, the method comprising:
crash testing the vehicle under the specific crash configuration and measuring crash acceleration information;
providing the occupant motion system with input data, including crash acceleration information;
causing the occupant motion system to assign values to variables; and
causing the occupant motion system to perform simulations using the values for each variable.

33. The method as claimed in claim 32, wherein the step of causing the occupant motion system to assign values to variables includes assigning statistical distributions to variables, the statistical distributions being comprised of a plurality of values representative of the values frequency of occurrence within a population.

34. The method as claimed in claim 33, wherein values are assigned to variables by being randomly selected from the distribution.

35. The method as claimed in claim 34, wherein the occupant motion system is further caused to perform a statistical analysis of the results of the simulations.

36. The method as claimed in claim 35, wherein the results of the statistical analysis are communicated to a network that enables a remote source to analyze the results of the statistical analysis.

37. A method for using an occupant motion system to predict the crashworthiness of a vehicle under a plurality of crash configurations, the method comprising:
crash testing the vehicle under a plurality of crash configurations and measuring crash acceleration information;
providing the occupant motion system with input data, including crash acceleration information from the plurality of crash configurations;
causing the occupant motion system to assign values to variables; and
causing the occupant motion system to perform simulations using the assigned values for each variable.

38. The method as claimed in claim 37, wherein the step of causing the occupant motion system to assign values to variables includes assigning statistical distributions to variables, the statistical distributions being comprised of a plurality of values representative of the values frequency of occurrence within a population.

39. The method as claimed in claim 38, wherein values are assigned to variables by being randomly selected from the distribution.

40. The method as claimed in claim 39, wherein the occupant motion system is further caused to perform a statistical analysis of the results of the simulations.

41. The method as claimed in claim 40, wherein the results of the statistical analysis are communicated to a network that enables a remote source to analyze the results of the statistical analysis.
